(19) United States
(12) Patent Application Publication
(10) Pub. No.: US 2011/0320285 A1
(43) Pub. Date: Dec. 29, 2011

(54) Entropic Market Saturation System and Method

(75) Inventor: Jeremy A. McEntire, Palo Alto, CA (US)

(73) Assignee: ADKNOWLEDGE, INC., Kansas City, MO (US)

(21) Appl. No.: 13/171,686

(22) Filed: Jun. 29, 2011

Related U.S. Application Data
(60) Provisional application No. 61/359,472, filed on Jun. 29, 2010.

(51) Int. Cl. G06Q 30/00

(52) U.S. Cl. 705/14.71

(57) ABSTRACT

The disclosed subject matter relates to methods, systems, and computer-usable storage mediums for generating competitive advertising bids for smaller geographic markets within a larger geographic market, based on bids for the larger market.

### CROSS-REFERENCES TO RELATED APPLICATIONS

This patent application is related to and claims priority from commonly owned U.S. Provisional Application Ser. No. 61/359,472, entitled: ENTROPIC MARKET SATURATION SYSTEM AND METHOD, filed on Jun. 29, 2010, the disclosure of which is incorporated by reference herein.

### TECHNICAL FIELD

The present disclosed subject matter relates to advertising on online networks, such as the Internet.

### BACKGROUND

The Internet provides advertisers of goods and services a channel through which advertisements can be presented to computer users in a manner that is sensitive to context, the interests of the computer user, and/or other factors relating to the interactive nature of the Internet. Generally, advertisers bid for the right to present advertisements to computer users, similar to how advertisers might purchase or bid for advertising time or space in radio or television programs, magazines, newspapers, or the like, in an effort to saturate the market with their advertisements.

### SUMMARY OF THE INVENTION

This document references terms that are used consistently or interchangeably herein. These terms, including variations thereof, are as follows.

The term “click”, “clicks”, “click on”, “clicks on” involves the activation of a computer pointing apparatus, such as a device commonly known as a mouse, on a location on a computer screen (monitor) or computer screen display, for example, an activatable portion or link, that causes an action of the various software and or hardware supporting the computer screen display.

A banner is a graphic that appears on the monitor or screen (“monitor” and “screen” of a computer used interchangeably herein) of a user, typically over a web page being viewed. A banner may appear on the web page in forms such as inserts, pop ups, roll ups, scroll ups, and the like.

A “web site” is a related collection of World Wide Web (WWW) files that includes a beginning file or “web page” called a home page, and typically, additional files or “web pages.” The term “web site” is used collectively to include “web site” and “web page(s).”

A uniform resource locator (URL) is the unique address for a file, such as a web site or a web page that is accessible on the Internet.

A server is typically a remote computer or remote computer system, or computer program therein, that is accessible over a communications medium, such as the Internet, that provides services to other computer programs (and their users), in the same or other computers.

A “creative” is electronic data representative of, for example, an advertising campaign, or other informational campaign or information, that appears as an image in graphics and text on the monitor of a user or intended recipient. The content for the creative may be static, as it is fixed in time. The creative typically includes one or more “hot spots” or positions in the creative, both in electronic data and the image that support underlying links, that are dynamic, as the destination that they link to is determined at the time the creative is activated, which may be upon the loading of a web page or the opening of an electronic communication, or e-mail with the creative, or at the time the creative is clicked on. The underlying links may also be “static”, in that they are placed into the creative at a predetermined time, such as when the creative is created, and fixed into the hot spots at that time. The hot spots include activatable graphics and/or text portions that overlie the links. When these activatable portions are activated or “clicked” on by a mouse or other pointing device, the corresponding underlying link is activated, causing the user's or intended recipient's browsing application or browser to be directed to the target web site corresponding to the activated link.

A “client” is an application that runs on a computer, workstation or the like and relies on a server to perform some operations, such as sending and receiving email.

“n” and “nth” in the description below and the drawing figures represents the last member of a series or sequence of servers, databases, caches, components, listings, links, data files, etc.

“Click-through” or “click-throughs” are industry standard terms for a user clicking on a link in an “electronic object,” such as an e-mail, creative, banner, listing on a web site, for example, a web site of a search engine, or the like, and ultimately having their browser directed to the targeted data object, typically a web site, associated with the link.

“Entropy” refers to the level of unpredictability in a system. In the context of the presently disclosed subject matter, the level of entropy among a set of bids for advertisements on the Internet is high when advertisers are submitting bids that are similar to bids from competing advertisers, because it is difficult to predict which advertiser will have the highest bid. On the other hand, the level of entropy is low when one advertiser has submitted a bid that is higher than the bids of other advertisers by a large margin.

The present disclosed subject matter provides advertisers, advertisement networks, website promoters and entities associated therewith, brokers, advertising agencies, application service providers or others (collectively “Promoters”) a way to optimize their bids for Internet-based advertising. More particularly, the present subject matter provides for accepting a bid from a Promoter for Internet-based advertisements targeted for a large geographic region, such as the United States, and generating a market-adjusted bid for each of a multitude of geographic regions within the larger geographic region. For example, the market for a given product in zip code one may be more competitive than the market for the same product in zip code two. Accordingly, the bids for advertisements of the product in Zip Code one are higher than the bids for advertisements for the same type of product in zip code two.

The present subject matter eliminates the need for a Promoter advertising on a large geographic scale to research the market in each smaller geographic region in order to place a bid that is competitive and not overly high or overly low compared to bids from Promoters local to the area. This allows a Promoter to more effectively saturate the markets of a large geographic region with its advertisements without spending more than is necessary to outbid local Promoters or spend time and resources researching the multitude of local markets within a large geographic region. Additionally, the present disclosed subject matter allows Promoters targeting only local markets to remain competitive with national or international market Promoters.

The present subject matter takes into account the level of entropy in each local market for a particular product or service within a larger geographic region, and seeks to maintain the level of entropy in each local market when placing a bid for a Promoter who has decided to spend a certain amount per bid on a larger, more general scale. For example, a Promoter may decide on an advertising bid amount of one dollar in a national advertising campaign for surfboards. The present disclosed subject matter provides for maintaining or maximizing the level of entropy in each smaller region within the national market by lowering the bid in land-locked regions where the surfboard market is weak and raising the bid in coastal regions where the market is strong. However, the average bid across the nation remains what the Promoter committed to: one dollar ($1.00).

In other words, the system keeps bids competitive over an entire area, such as a country in both the national, regional and the smaller geographic markets. Staying with this example, with the national bid being $1.00, a large national market may have to be bided at $1.80, while the smaller geographic market may be bided at $0.20, to be competitive in these markets. In this example, the $1.00 bid is a mean bid.

An embodiment of the disclosed subject matter is a method for generating competitive advertising bids. More specifically, the method takes into account smaller geographic markets within a larger geographic market, and generates a bid for each of the smaller geographic markets based on a general bid for the larger geographic market and existing bids and corresponding entropy for advertising bids in each of the smaller geographic markets. As a first step, the method involves receiving, through a communications network, for example, the Internet, the general bid for advertising in connection with a particular type of good or service. The general bid applies to a large geographic region, for example, United States.

As a next step, for each smaller geographic market within the larger geographic market, the method involves referencing a database, for example a structured query language (SQL) addressable relational computer database, containing third-party bids for advertising in connection with the particular type of good or service. As a next step, the method involves generating a bid for the smaller market based on the general bid including calculating the level of entropy in the smaller market and determining whether to use an amount for the smaller-market bid that is an increase upon, a decrease upon, or equal to the general bid, to ensure competitiveness with other bids in the smaller market, based on the entropy in the smaller market. The method also includes ensuring that the average of the bids for the smaller markets is substantially equal to the general bid.

Another embodiment of the disclosed subject matter is a system for generating competitive advertising bids for smaller geographic markets within a larger geographic market, based on a general advertising bid for the larger market. The system includes at least one server containing at least one computer processor, a memory, a connection to a communications network, and a connection to at least one database located in said memory or on said communications network, the memory containing computer processor executable instructions for carrying out the method disclosed above.

Another embodiment of the disclosed subject matter is directed to a method for generating bids for advertising. The method comprises receiving, through a computer network, a general bid for the larger geographic market, such as a national or regional market, for a particular type of good or service, and, for at least one smaller geographic market within the larger geographic market, generating a bid for the smaller market based on the general bid subject to an entropy factor.

Another embodiment is directed to a method or process for generating bids for advertising over a communications network. The method includes receiving, by at least one main server (the main server being one or more servers, machines, computer components and/or combinations thereof) linked to the computer network, a plurality of general bids for a first market, for a particular type of good or service; and generating, by the at least one main server, a bid for a second market within the first market, based on the plurality of general bids and an entropy factor (EF). The first market is, for example, a predetermined market, such as a national, regional global or other designated geographic market, and the second market is a local market within the predetermined market. Additionally, the main server provides the bid for the second market to a computer of an entity associated with a general bid for the first market, for example, by electronic communication methods including e-mail. Also, the receiving the plurality of general bids includes receiving the general bids from at least one database associated with the at least one main server.

Another embodiment is directed to a system for generating bids for advertising over a communications network. The system comprises at least one server for linking to a communications network, which comprises a storage medium for storing computer components, and a processor for executing the computer components. The computer components include a first component for receiving a plurality of general bids for a first market, for a particular type of good or service; and a second component for generating a bid for a second market within the first market, based on the plurality of general bids and an entropy factor (EF). There is also a third component for providing the bid for the second market, to a computer of an entity associated with a general bid for the first market, by methods such as electronic mail (e-mail) and the like. The system also includes at least one database for storing general bids accessible by the first component to receive the general bids.

Another embodiment is directed to a system for generating bids for advertising over a communications network. The system comprises at least one server in electronic, communication, including data communication, with at least one database. The at least one server is for linking to a communications network and is configured for i) receiving a plurality of general bids for a first market, for a particular type of good or service; and ii) generating a bid for a second market within the first market, based on the plurality of general bids and an entropy factor (EF). The at least one database is configured for storing general bids accessible by the at least one server to receive the general bids.

A further embodiment of the disclosed subject matter is a computer-usable storage medium. The computer usable storage medium contains computer processor executable instructions for carrying out the methods disclosed above.

### BRIEF DESCRIPTION OF THE DRAWINGS

Attention is now directed to the drawing figures, where like or corresponding numerals indicate like or corresponding components. In the drawings:

FIG. 1 is a diagram of an exemplary system supporting the disclosed subject matter;

FIG. 2 is a flow diagram (flow chart) detailing an exemplary process performed in accordance with the disclosed subject matter;

FIG. 3 is a screen shot of a web page or home page of an exemplary web site;

FIG. 4 is a Table for the Bid Database of the system detailed in FIG. 1;

FIG. 5 is an Account Listing for the Advertiser Database of the system detailed in FIG. 1;

FIG. 6 is a diagram of the national (larger) and smaller geographic regions associated with the disclosed subject matter;

FIG. 7A is a diagram of probability versus bids; and

FIG. 7B is a diagram of entropy versus bids.

### DETAILED DESCRIPTION OF THE DRAWINGS

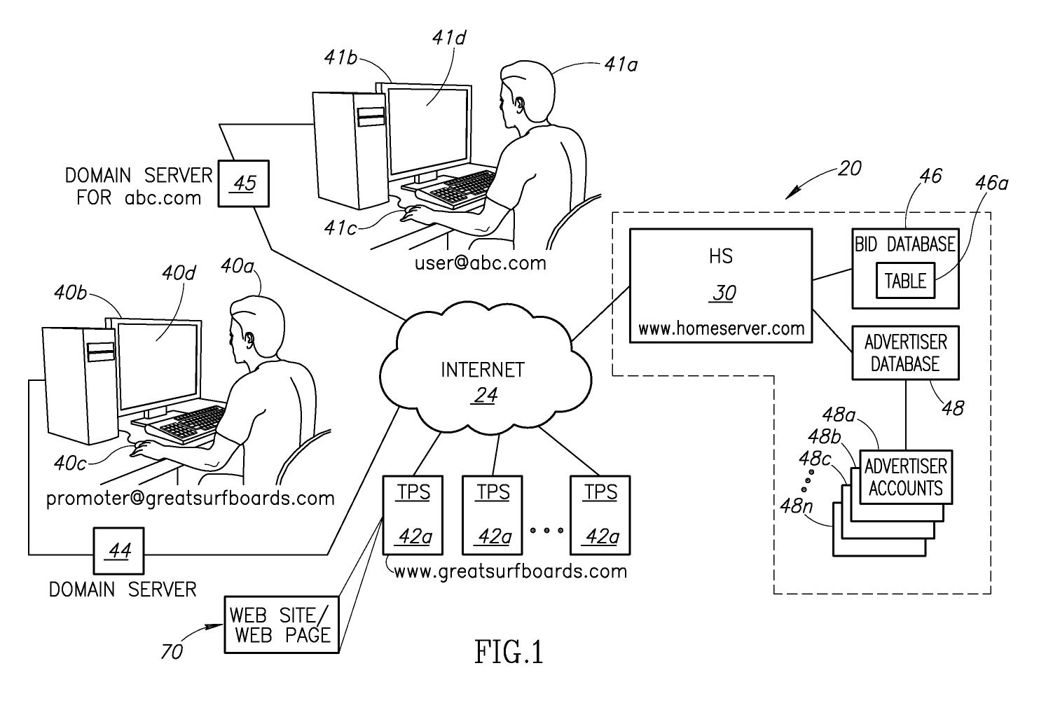

FIG. 1 is a diagram showing the present disclosed subject matter in an exemplary operation. The present disclosed subject matter is shown as a system 20, formed of various servers and server components that are linked to a network, computer network, or communications network, such as a wide area network (WAN), which may be a public network, for example, the Internet 24. Throughout this document, the terms “linked,” includes wired or wireless connections or combinations thereof, for electronic and/or data communication, direct or indirect, between any of the servers, machines, computerized components detailed herein or any of the aforementioned servers, machines, computerized components and the communications network, e.g., the Internet 24.

There are, for example, one or more servers that form the system 20, with the main computerized component of the system 20 including the home server (HS) 30, also known as the main server. Additionally, the system 20 is shown in operation as linked, over the communications network, e.g., the Internet 24, to one or more third-party servers (TPS) 42a-42n. The third-party servers are controlled, by parties, including advertisers or other entities that may or may not be related to the entity associated with the home server (HS) 30. In this example, the servers 30 and 42a-42n are linked to the Internet 24 and are in communication with one another. The servers 30 and 42a-42n contain multiple components for performing the methods disclosed herein. The components are based in hardware, software, or combinations thereof. The servers 30 and 42a-42n may also have internal storage media and/or be associated with external storage media. The servers 30 and 42a-42n are linked (either directly or indirectly) to an endless number of other servers, computers, and the like, via the Internet 24.

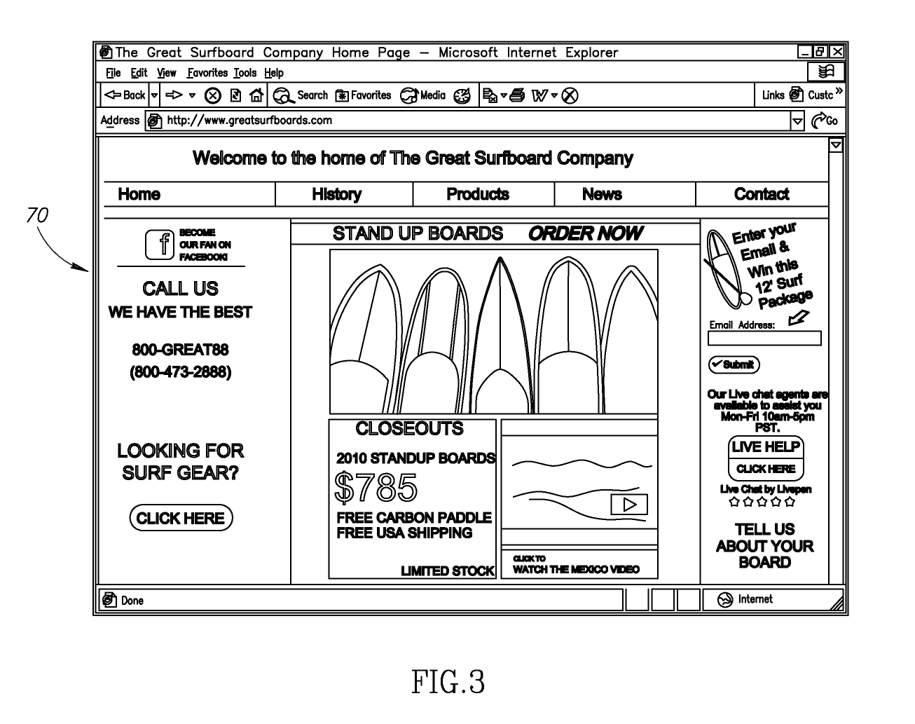

Also shown in FIG. 1, there is an exemplary Promoter 40a, representative of all promoters and others associated with an advertiser, web site, or the like. For example, promoter 40a has an e-mail address of: promoter@greatsurfboards.com, and represents the advertiser: The Great Surfboard Company, which has the URL www.greatsurfboards.com, and whose website 70 (of web pages including the home page 70 of FIG. 3) is hosted by a third party server, such as server 42a.

There is a user 41a (whose e-mail is user@abc.com), representative of all users. Each promoter 40a and user 41a has a computer 40b and 41b, respectively, (such as a multimedia personal computer with a Pentium® CPU that employs a Windows® operating system) that is linked to the Internet 24 and which uses a web browser, browsing software, application, or the like to access web sites or web pages from various servers and the like, on the Internet 24. Exemplary web browsers/web browsing software include Internet Explorer® from Microsoft, Redmond, Wash., and Mozilla Firefox® from Mozilla Foundation, Mountain View, Calif. The Promoter's 40a and the user's 41a computers 40b and 41b, link to the Internet 24 through their respective domain servers 44, 45, and each computer 40b, 41b further comprises a mouse 40c and 41c and a monitor 40d and 41d, respectively.

While various servers and computers have been listed, this is exemplary only, as the present disclosed subject matter can be performed on an endless number of servers, computers, and associated components that are in some way linked to a network, such as the Internet 24. Additionally, all of the aforementioned servers and computers include components for accommodating various functions, in hardware, software, or combinations thereof, and typically include storage media, either therein or associated therewith. Also, the aforementioned servers, computers, computerized components, storage media, and other components can be linked to each other or to a network, such as the Internet 24, either directly or indirectly.

The home server (HS) 30 is of an architecture that includes one or more components, processors, modules, engines, and the like, for providing numerous additional server functions and operations, for example, comparison and matching functions, policy and/or rules processing, various search and other operational engines, browser directing and redirecting functions (for example, in response to or resulting from click-throughs), electronic communications, e-mail and banner transmission, e-mail and banner creation and selection, including selecting creatives for e-mail advertisements, and the like. The home server (HS) 30 includes various processors, including microprocessors, for performing the server functions and operations detailed herein, including those for generating and supporting HTML documents and its associated data, such as JavaScript and the like, for monitoring time on a web site or web page as well as hardware and software for analyzing the recorded time, as well as for detecting invalid or fraudulent clicks based on their positioning inside browser windows. U.S. patent application Ser. No. 11/844,983 (U.S. Patent Application Publication No. US 2008/0052629 A1), the disclosure of which is incorporated herein by reference, discloses further information on this functionality of the home server (HS) 30.

The home server (HS) 30 may also include storage media, devices, etc, either internal or associated therewith. This storage media is operationally coupled to the aforementioned components, processors, modules, engines, and the like, for providing the server functions and operations described herein. The storage media may store documents and/or data corresponding to these documents, such as hypertext markup language (HTML) coded documents (and/or data corresponding thereto), that are sent by the home server (HS) 30 (for example, as HTML coded documents), detailed below. By “home server”, it is meant all servers and components necessary to support the home server (HS) 30 in the requisite function, such as imaging servers, as disclosed in U.S. patent application Ser. Nos. 10/915,975 (U.S. Patent Application Publication No. US 2005/0038861 A1), 11/361,480 (U.S. Patent Application Publication No. US 2006/0212349 A1), and 11/774,106 (U.S. Patent Application Publication No. US 2008/0098075 A1), all three of these patent applications, the disclosures of which are incorporated by reference herein, e-mail API servers, and tag servers, as disclosed in U.S. patent application Ser. No. 11/774,106, and caches, databases and the like, as disclosed in U.S. patent application Ser. Nos. 10/915,975, 11/361,480 and 11/774,106, respectively. For explanation purposes, the home server (HS) 30 has a uniform resource locator (URL) of, for example, www.homeserver.com.

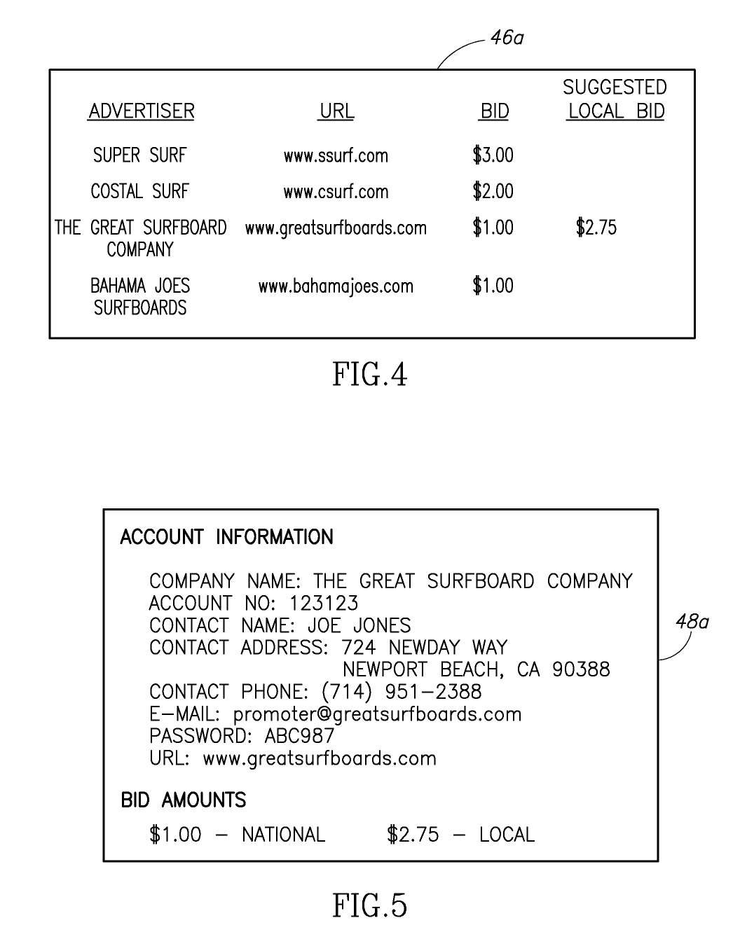

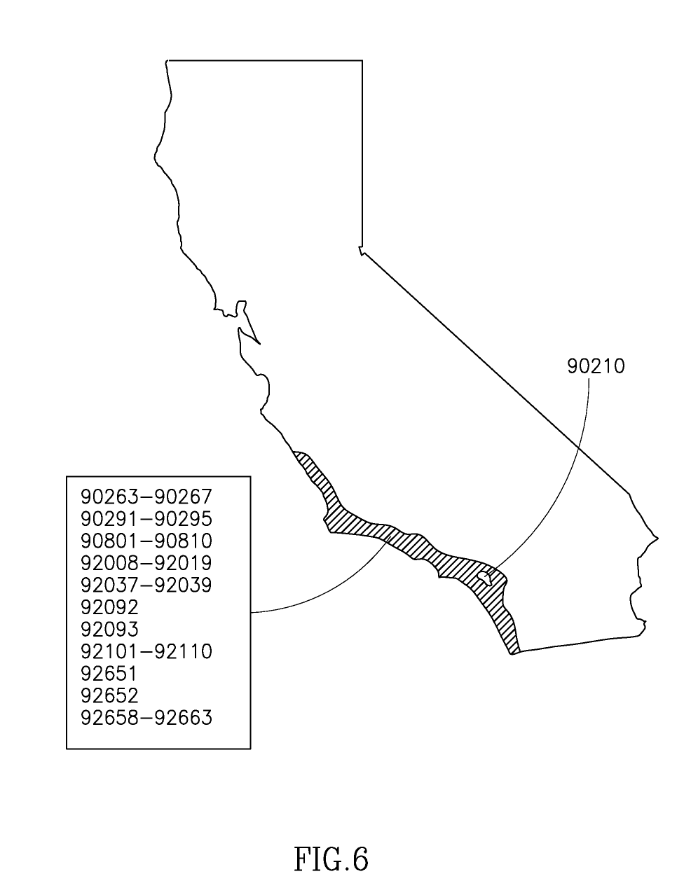

There are also databases for bids 46 and advertisers 48, these databases 46, 48 are either part of (as shown) or connected to the home server 30. The bid database 46 includes a table 46a, where bids associated with advertisers are listed. An exemplary table 46a is shown in FIG. 4. The advertiser database 48 includes advertiser accounts, such as the account 48a for the advertiser, The Great Surfboard Company (with the URL www.greatsurfboards.com), as shown in FIG. 5.

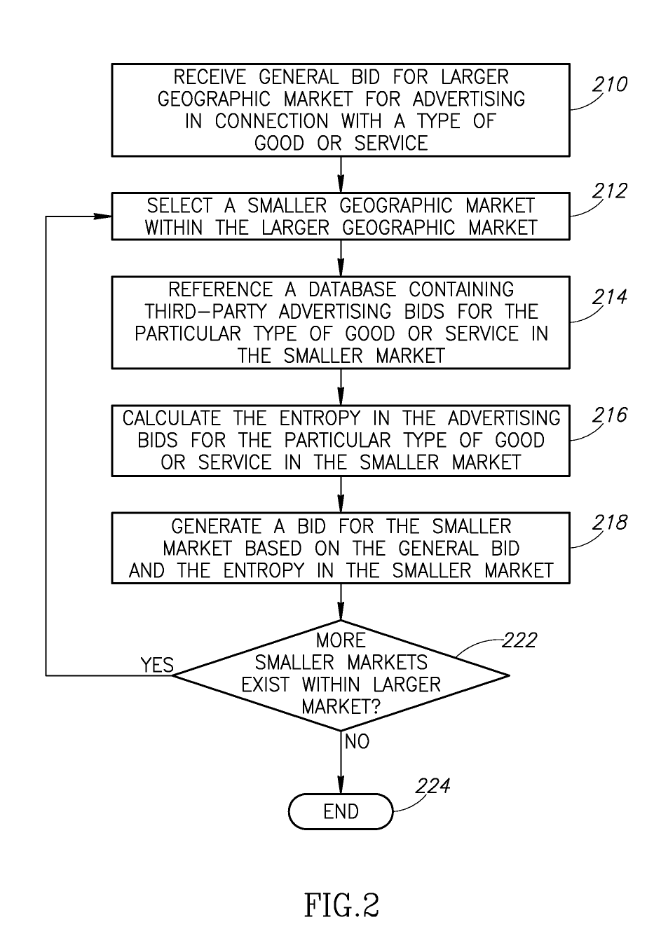

FIG. 2 is a flow diagram (flow chart) detailing an exemplary process performed in accordance with the disclosed subject matter. At step 210, the home server 30 receives a bid, typically electronically over the Internet 24, from a computer of a Promoter, such as the computer 40b of the Promoter 40a for the advertiser, The Great Surfboard Company. The Promoter 40a submits a bid to advertise in connection with a particular good, for example, surfboards, on a national scale. For illustrative purposes, the bid entered by Promoter 40a is one dollar ($1.00). In this example, the Promoter 40a submits the bid electronically through a webpage hosted by the home server 30.

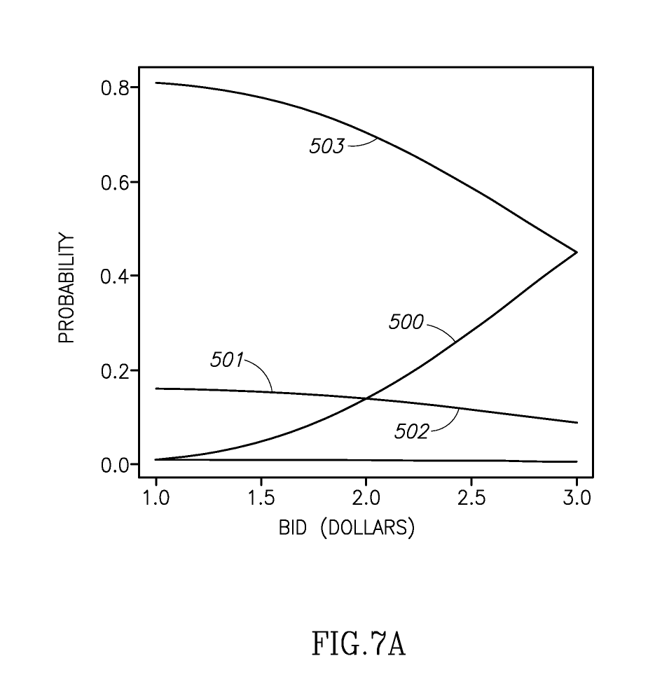

The home server 30, at step 212, selects a smaller geographic market (for example, the Zip Code 90210) within the larger geographic e.g., national, market (for example, the shaded area of multiple Zip Codes) for surfboards, as shown in FIG. 6. The home server 30 references a database of smaller geographic markets within a larger geographic market. The smaller geographic markets are indexed, for example, by zip code. Having selected one of the smaller geographic markets, the home server 30 proceeds to step 214 where it references the bid database 46 with a table 46a (FIG. 4) containing existing bids for advertising in connection with any particular good or service for any particular smaller geographic market. For example, as shown in FIG. 6 for the Zip Code 90210, corresponding to Beverly Hills, Calif., the local area or smaller geographic market within the national market, the blank area (island) within the shaded national area of FIG. 6, existing bids, for advertising in connection with surfboards in the 90210 area code, are $3, $2, $1, and $1 (the national market bids in the bid database 46 as listed in the Table 46a of FIG. 4). At step 216, the home server 30 calculates the entropy (EF) for the existing bids, for the particular good or service, for example, surfboards. The equation for entropy (or entropy factor), collectively expressed as “EF”, in the market (for example, the surfboard market) is:

entropy=−SUM(i*log(i))

For the given bids ($3.00, $2.00, $1.00. $1.00, as listed above, the “bids” or National Market Bids in the Table 46a of FIG. 4), the entropy or entropy factor (EF) is calculated as follows (the symbol ̂ represents a power, for example, ŷ4=y⁴, and * is the multiplication operator):

$$entropy = EF = - SUM ( ( {bid}^{⋀} 4 \text{/} SUM ( {all\_bids}^{⋀} 4 ) ) * log ( ( {bid}^{⋀} 4 \text{/} SUM ( {all\_bids}^{⋀} 4 ) ) ) SUM ( {all\_bids}^{⋀} 4 ) is ( {3}^{⋀} 4 + {2}^{⋀} 4 + {1}^{⋀} 4 + {1}^{⋀} 4 ) = ( 81 + 16 + 1 + 1 ) = 99 \\ entropy = - SUM ( {bid}^{⋀} 4 \text{/} 99 * log ( {bid}^{⋀} 4 \text{/} 99 ) ) = - ( 81 \text{/} 99 * log ( 81 \text{/} 99 ) + 16 / 99 * log ( 16 \text{/} 99 ) + 1 \text{/} 99 * log ( 1 \text{/} 99 ) + 1 \text{/} 99 * log ( 1 \text{/} 99 ) ) = 0.239542202 = EF$$

In the equation above, as long as the same base is used for the logs, the relative results are the same. As stated previously, the entropy (or entropy factor) in the market (expressed also as EF) represents the uncertainty as to which bid will “win” an auction. For example, if the entropy is high, the market is difficult to enter and may require a higher than normal bid for such entry. Also, the entropy or entropy factor is representative of a weight, and in the case where the entropy is high, the advertiser's bid for the smaller geographic market will have to be higher relative to the mean bid (of the existing national market bids).

In the case of advertising in the system 20, the highest bid is typically rewarded with the majority of the advertising opportunities. To ensure that each advertising opportunity is matched with a bid (a 100 percent chance that each advertising opportunity will be provided with a bid), each of the bids is normalized to make the bids uniform across the entire market. Normalization is according to the following equation, with the normalized bids then stored in a stochastic vector:

Normalized bid=(original bid̂4)/((sum(all bidŝ4))

As a result, the sum of the numbers in the stochastic vector is one. Each entry in the stochastic vector corresponds to the percentage chance that, in the normal course of directing a user 41a to advertisements hosted by third party servers (TPS) 42a-42n, the home server 30 will choose the corresponding Promoter's advertisement to be presented to computer user 41a. As can be seen, an entropy-maximizing bid is a one that is competitive with other bids and which is not disproportionately high or low as compared to the other bids.

At step 218, the home server 30 generates a bid to maximize the level of entropy in the smaller geographic market for advertising in connection with a particular product or service, in this case, surfboards. In other words, the home server 30 seeks to generate a bid that it is competitive with the other existing bids and is based on the general bid that the Promoter 40a submitted for advertising on a national scale. Considering that two of the existing bids are one dollar ($1.00), another bid is two dollars ($2.00), and another bid is three dollars ($3.00), the home server 30 determines that a competitive bid would be within the range of one ($1.00) to three dollars ($3.00), and, in order to maximize the competitiveness of the bid and the entropy in the market, the bid should be higher than one dollar ($1.00). For example, for the $1.00 bid for the 90210 zip code, as discussed above, the entropy-based bid is determined by the code segment, as written in R, as follows:

bid=c(3,2,1,1)
x=seq(min(bid),max(bid),by=.01)
p=matrix(nrow=length(x),ncol=length(bid)+1)
for(i in 1:length(x)){ p[i,] = c(x[i]\hat{ }4,bid\hat{ }4)/(sum(bid\hat{ }4)+x[i]\hat{ }4) }
plot(x,p[,1],ylab=“probability”,xlab=“bid”,ylim=range(p))
for(i in 2:ncol(p)){ lines(x,p[,i],col=i) }

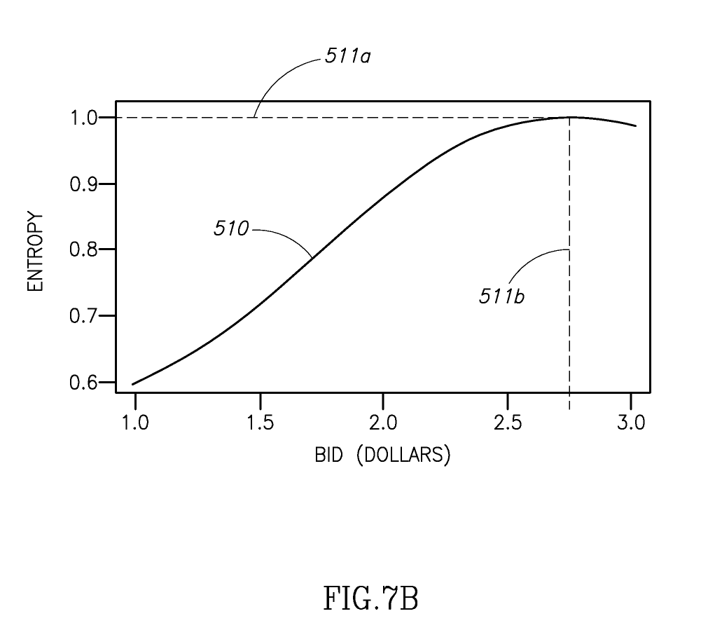

In the code segment above:
bid=c(3,2,1,1), where 3 represents the $3 bid, 2 represents the $2 bid and 1 represents each of the $1 bids, including the $1 bid for the national or larger market by the promoter of www.greatsurfboards.com for the Great Surfboard Company, and the plot for: plot(x,p[,1],ylab=“probability”,xlab=“bid”,ylim=range(p)) for(i in 2:ncol(p)){lines(x,p[,i],col=i)}, is represented by FIG. 7A.

In FIG. 7A, line 500 is the probability for selecting the new advertiser's, i.e., The Great Surfboard Company's (www.greatsurfboards.com), bid, given the value of the bid. Lines 501-503 are the probabilities for the other bidders (who have fixed bids at 0.1, 0.25, 0.75, 0.80, 0.95, 0.97, 1).

Now, utilizing the entropy or entropy factor (EF), for example, as determined above (entropy or “e”=0.239542202), as applied to the following code segment, including a formula (in R language), with the aforementioned bids of $3.00, $2.00, $1.00 and $1.00:

e=c( )
for(i in 1:length(x)){ e[i]=−sum(p[i,]*log(p[i,])) }
plot(x,e,ylab=“entropy”,xlab=“bid”)

and

newbids = c(bid,x[which(e==max(e))])
> cbind(newbids, newbids\hat{ }4/sum(newbids\hat{ }4))
newbids
[1,] 3.00 0.518594473
[2,] 2.00 0.102438414
[3,] 1.00 0.006402401
[4,] 1.00 0.006402401
[5,] 2.75 0.366162311

FIG. 7B, along line 510, shows this result graphically. Taking the point at 100% entropy (line 511a), corresponding to the maximum or highest entropy for the market, results in the advertiser for The Great Surfboard Company being recommended or suggested to bid $2.75 (line 511b) for the local geographic market (the Suggested Local Bid in the Table 46a of FIG. 4 with the bids for this advertiser, The Great Surfboard Company, listed in the corresponding Account 48a of FIG. 5), for example, the Zip Code 90210. This bid maximizes entropy for the collection (without changing other advertiser's bids). This bid suggestion is communicated from the home server 30 to the Promoter 40a, e.g., promoter@greatsurfboards.com, typically in an e-mail or other electronic communication. The Promoter 40a may then place this bid, or any other bid for the smaller geographic market with the home server 30, as detailed above.

The process moves to step 222, where the home server 30 determines whether another smaller geographic market exists in larger geographic market, and if so, moves to step 212. In this example, the home server 30 will repeat the process for every Zip Code in the geographic region, e.g., the United States. In the process, the home server 30 will generate entropy-maximizing bids for land-locked geographic markets where bids for advertising are for surfboards are lower. When the home server 30 has generated a bid for every smaller geographic market within the larger national market, the home server 30 moves to step 224 (END), indicating that it has completed the process.

As a result of this process (method), the system and method of automatically generating entropy-maximizing bids therefore allows a national-scale Promoter 40a to place cost-effective bids in each smaller market without being required to independently research each market to determine what a competitive bid would be. It also allows local advertisers submitting bids to remain competitive with a national-scale Promoter who might otherwise submit an unreasonably high bid for a weak local market.

It is to be understood that all communication between computers and databases as disclosed herein is possible because they are connected together as part of the same computer or networked together via a wired or wireless network. It should also be understood that the databases discussed herein could be embodied in one or more flat files or in relational databases, and that they could be stored in the memory of one computer or distributed across multiple computers.

The above-described processes or methods, including portions thereof, can be performed by software, hardware, and combinations thereof. These processes or methods and portions thereof can be performed by computers, computer-type devices, workstations, processors, micro-processors, other electronic searching tools and memory, and other storage-type devices associated therewith. The processes and portions thereof can also be embodied in programmable storage devices, for example, compact discs (CDs) or other discs including magnetic, optical, etc., readable by a machine or the like, or other computer usable storage media, including magnetic, optical, or semiconductor storage, or other source of electronic signals.

The processes (methods) and systems, including components thereof, herein have been described with exemplary reference to specific hardware and software. The processes (methods) have been described as exemplary, whereby specific steps and their order can be omitted and/or changed by persons of ordinary skill in the art to reduce these embodiments to practice without undue experimentation. The processes (methods) and systems have been described in a manner sufficient to enable persons of ordinary skill in the art to readily adapt other hardware and software as may be needed to reduce any of the embodiments to practice without undue experimentation and using conventional techniques.

While preferred embodiments of the disclosed subject matter have been described, so as to enable one of skill in the art to practice the present disclosed subject matter, the preceding description is intended to be exemplary only. It should not be used to limit the scope of the disclosed subject matter, which should be determined by reference to the following claims.

1. A method for generating bids for advertising over a communications network, comprising:
receiving, by at least one main server linked to the computer network, a plurality of general bids for a first market, for a particular type of good or service; and
generating, by the at least one main server, a bid for a second market within the first market, based on the plurality of general bids and an entropy factor (EF).

2. The method of claim 1, wherein the first market is predetermined market and the second market is a local market within the predetermined market.

3. The method of claim 1, wherein the entropy factor (EF) is determined in accordance with the formula:
EF=−SUM((bid̂4/SUM(all_bidŝ4))*log((bid̂4/SUM(all_bidŝ4)))

4. The method of claim 1, additionally comprising: providing, by the at least one main server, the bid for the second market, to a computer of an entity associated with a general bid for the first market.

5. The method of claim 1, wherein the receiving a plurality of general bids includes receiving the general bids from at least one database associated with the at least one main server.

6. The method of claim 1, wherein the at least one main server includes one server.

7. The method of claim 1, wherein the at least one main server includes a plurality of servers.

8. A system for generating bids for advertising over a communications network, comprising:
at least one server for linking to a communications network comprising:
a storage medium for storing computer components; and
a processor for executing the computer components comprising:
a first component for receiving a plurality of general bids for a first market, for a particular type of good or service; and
a second component for generating a bid for a second market within the first market, based on the plurality of general bids and an entropy factor (EF).

9. The system of claim 8, additionally comprising: a third component for providing the bid for the second market, to a computer of an entity associated with a general bid for the first market.

10. The system of claim 8, additionally comprising: at least one database for storing general bids accessible by the first component to receive the general bids.

11. The system of claim 8, wherein the at least one server includes one server.

12. The system of claim 8, wherein the at least one server includes a plurality of servers.

13. A system for generating bids for advertising over a communications network, comprising:
at least one server for linking to a communications network configured for i) receiving a plurality of general bids for a first market, for a particular type of good or service; and ii) generating a bid for a second market within the first market, based on the plurality of general bids and an entropy factor (EF); and
at least one database in electronic communication with the at least one server for storing general bids accessible by the at least one server to receive the general bids.

14. The system of claim 13, wherein the at least one server is additionally configured for providing the bid for the second market, to a computer of an entity associated with a general bid for the first market.
